(19) United States
(12) Patent Application Publication
(10) Pub. No.: US 2008/0229906 A1
(43) Pub. Date: Sep. 25, 2008

(54) ELECTRIC STRINGED MUSIC INSTRUMENT WITH MUSIC TUNER

(76) Inventors: Bong Yol Kwak, Tokyo (JP); Akira Karasawa, Matsudoshi (JP)

Correspondence Address: PARK LAW FIRM, 3255 WILSHIRE BLVD, SUITE 1110, LOS ANGELES, CA, 90010, US

(21) Appl. No.: 11/938,405

(22) Filed: Nov. 12, 2007

(30) Foreign Application Priority Data
Mar. 20, 2007 (JP) 2007-107579

(51) Int. Cl. G10G 7/02

(52) U.S. Cl. 84/454

(57) ABSTRACT

A music tuner comprising a contact sensing device, a non-contact sensing device, or a combination of both, is integrated onto the body of an electric stringed music instrument. The present invention aims to make it more convenient for the user of the electric ukulele by eliminating the need to separately account for the music tuner and by preventing the music tuner from being misplaced or lost.

### BACKGROUND OF THE INVENTION

The present invention relates to an electric stringed music instrument with a music tuner. More particularly, this invention relates to a music tuner that is integrated onto the body part of an electric stringed music instrument.

A music tuner allows a user to tune a music instrument so that the music instrument projects a sound at a preferred frequency. A typical music tuner determines the frequency of sound emanating from a music instrument and displays the frequency of that sound on a display screen. The user is then able to compare that frequency to a predetermined frequency and adjust the music instrument accordingly to match that predetermined frequency.

Music tuners generally determine the frequency of sound by detecting sound vibrations via a sound sensing device that comprises a contact sensing device, a non-contact sensing device, or a combination of both. A contact sensing device, usually a piezoelectric device, senses sounds by detecting vibrations through physical contact with the music instrument. A non-contact sensing device, usually a microphone, senses sounds by detecting sound waves through the air.

The music tuner can automatically select which type of sound sensing device to use depending on the environment or select the type of sound sensing device by use of a switch. In a relatively noisy environment, the music tuner can automatically select the contact sensing device to determine the frequency of sound. This is advantageous because a non-contact sensing device such as a microphone would be ineffectual in distinguishing the sound produced by the user's music instrument and the sound produced by the environment.

### SUMMARY OF THE INVENTION

The present invention aims to make it more convenient for the user to tune a music instrument by integrating a music tuner onto the body part of the music instrument. Integrating the music tuner onto the body part of the music instrument eliminates the need to separately account for the music tuner. A preferred embodiment of this invention integrates a music tuner onto the body part of an electric ukulele.

An electric stringed music instrument according to the present invention comprises a head part, neck part, and a body part. The body part comprises a front surface and a back surface. There are a predetermined number of strings that produce sound and are placed over the neck part and the body part. A music tuner comprising a display screen and a sound sensing device is placed in the body part below the strings. The music tuner is placed underneath the strings so that the display screen appears flush with the front surface of the body part.

The strings of an electric ukulele are usually made of nylon. Nylon strings on an electric ukulele tend to loosen easily in a shorter amount of time, producing a sound at a different frequency than the desired frequency. Nylon strings must be adjusted more frequently than other types of strings. Integrating a music tuner onto the body part of an electric ukulele makes it easier for the user to tune the nylon strings more frequently.

When a user plays the electric stringed music instrument, the vibration of the strings produce sounds. The sound sensing device of the music tuner senses the frequency of the sounds produced and displays the frequency of that sound on the music tuner's display screen. The display screen indicates the frequency of a sound produced by the strings and the difference from a target frequency. The user can then compare the difference between the actual frequency and the preferred or target frequency and can tune the electric stringed music instrument accordingly.

The sound sensing device of the music tuner comprises a contact sensing device, a non-contact sensing device, or a combination of both. A contact sensing device senses sounds by physically contacting the strings. The contact sensing device is a piezoelectric device. A non-contact sensing device senses sounds by detecting the vibration of the strings through the air. The non-contact sensing device is a microphone. The music tuner can automatically select one of the two sound sensing devices depending on the environment or the user can select one of the two sound sensing devices by the use of a switch.

The music tuner is integrated onto the electric stringed music instrument by placing the music tuner into a hole cut out in a corresponding shape. The music tuner is held in place by one or more screws on the back surface of the body part. The display screen appears flush with the front surface of the body part. The music tuner is integrated onto the body part underneath the strings. Although the strings are outstretched over the top of the display screen, the strings are thin enough so that the strings do not disturb the user's view of the display screen.

The music tuner comprises a predetermined number of buttons that, when pressed, select a corresponding target frequency to be compared to the frequency of sound from each corresponding string of the electric stringed music instrument. The number of buttons corresponds to the number of strings. A preferred embodiment of this invention is an electric ukulele, which comprises of four strings. Thus, the music tuner integrated onto an electric ukulele would have four buttons.

### BRIEF DESCRIPTION OF THE DRAWINGS

FIG. 1 is an illustration of a front perspective view of an electric ukulele with a music tuner.

FIG. 2 is an illustration of a front view of the display screen of the music tuner.

FIG. 3 is a schematic diagram of the top view of the body part of the electric ukulele showing the music tuner affixed to the back surface of the body part by the use of screws.

FIG. 4 is an illustration of the top view of the music tuner with screws.

FIG. 5 is an illustration of the back view of the music tuner with battery cap.

FIG. 6 is an illustration of the front surface of the body part with the display screen of the music tuner.

FIG. 7 is an illustration of the back surface of the body part with the music tuner affixed by the use of screws.

FIG. 8 is an illustration of a block diagram representing a sound sensing device.

### DETAILED DESCRIPTION OF THE INVENTION

The present invention is described with reference to the drawings. The preferred embodiment of this invention is an electric ukulele 1 with an integrated music tuner 6. The present invention aims to make it more convenient for the user of the electric ukulele 1 by eliminating the need to separately account for the music tuner 6 and by preventing the music tuner 6 from being misplaced or lost.

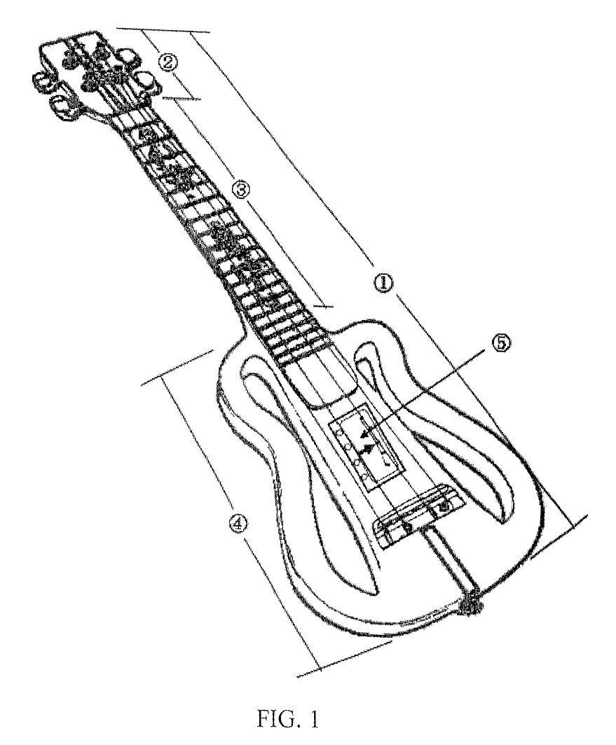

FIG. 1 is an illustration of a front perspective view of an electric ukulele 1. FIG. 1 shows a head part 2, a neck part 3, a body part 4, and a display screen 5 of a music tuner. A predetermined number of strings 15 are placed over the head part 2, neck part 3, body part 4, and display screen 5. In a preferred embodiment of an electric ukulele 1, the number of strings 15 is four. The display screen 5 is oriented upside-down on the front surface of the body part 4 and can be seen through the strings 15. A preferred embodiment of the electric ukulele 1 has strings 15 made of nylon.

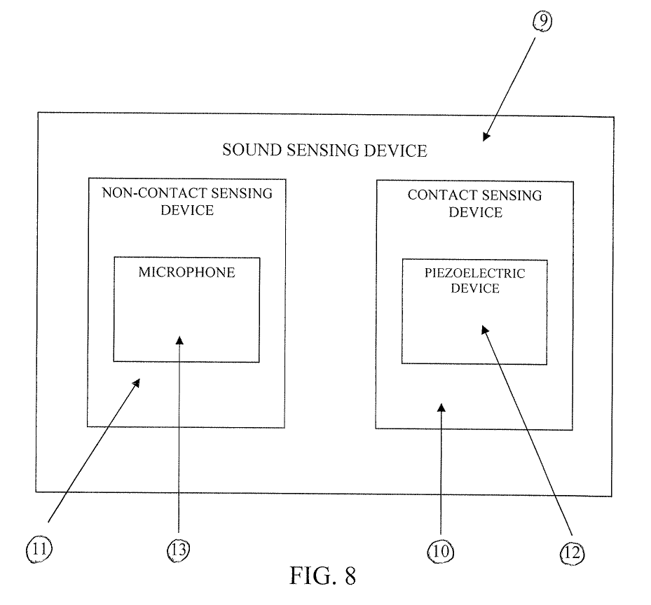

FIG. 8 is a block diagram representing the contact sensing 10 and non-contact sensing 11 functionality of a sound sensing device 9 of a music tuner 6. The sound sensing device 9 of a music tuner 6 comprises a contact sensing device 10, a non-contact sensing device 11, or a combination of both. A contact sensing device 10 senses sounds by physically contacting the strings 15. The contact sensing device 10 is a piezoelectric device 12. A non-contact sensing device 11 senses sounds by detecting the vibration of the strings 15 through the air. The non-contact sensing device 11 is a microphone 13. The music tuner 6 can automatically select one of the two sound sensing devices depending on the environment or the user can select one of the two sound sensing devices by the use of a switch.

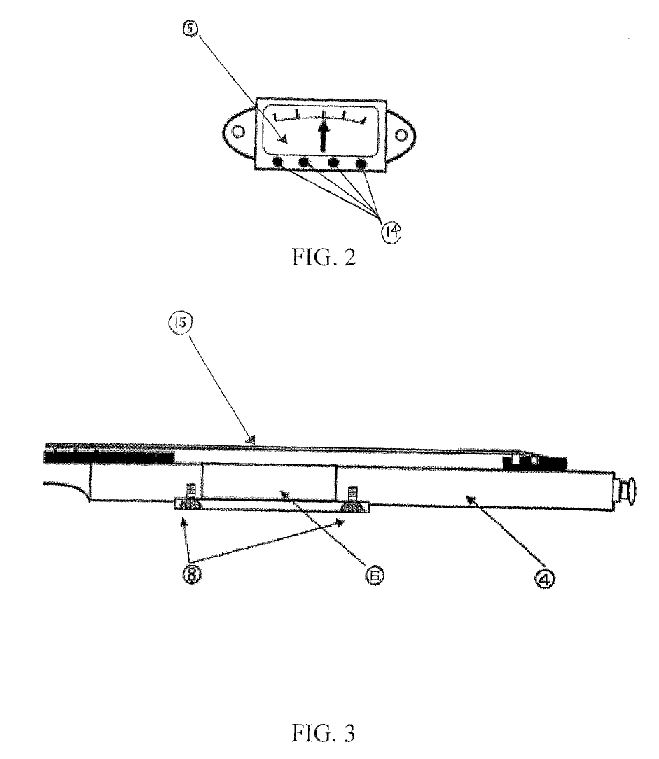

FIG. 2 is an illustration of the front view of the display screen 5 of the music tuner 6. The display screen 5 comprises four buttons 14 that correspond to each target frequency. The user can choose a target frequency by pressing one of the buttons 14. Each button 14 corresponds to one of the strings 15. The display screen 5 comprises a needle that indicates the degree of difference in frequency of the sound produced by the strings 15 and the target frequency. The user is then able to compare the difference between the actual frequency of sound produced by the vibration of the strings 15 and the target frequency and tune the strings accordingly.

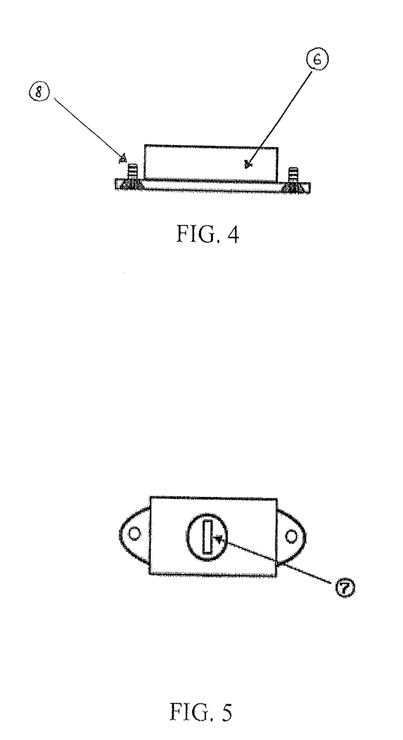

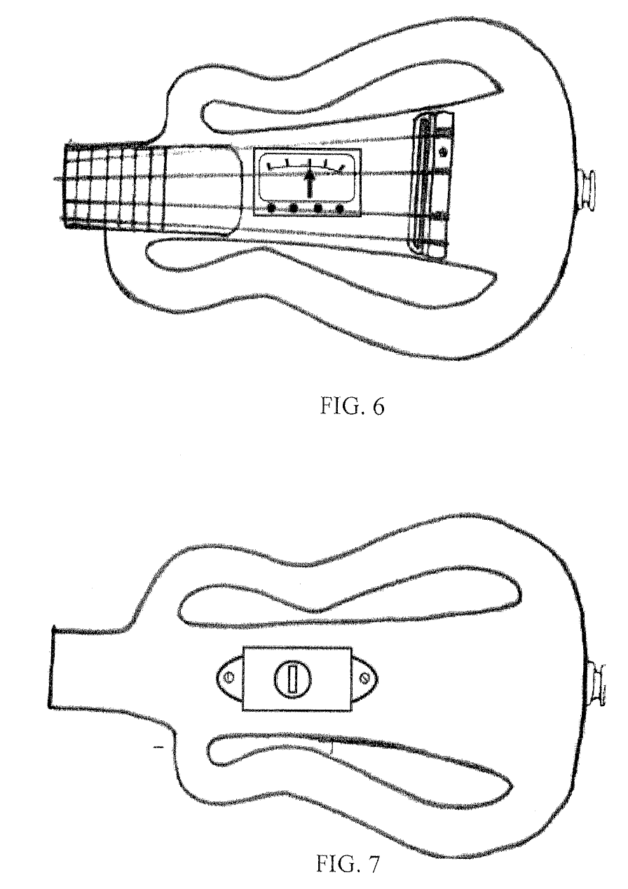

FIG. 3 is a schematic diagram of the top view of the music tuner 6 affixed to the back surface of the body part 4 by the use of screws 8. FIG. 4 is an illustration of the top view of the music tuner 6 with screws 8. A hole in the corresponding shape of the music tuner 6 is cut out of the body part 4 of the electric ukulele 1. The music tuner 6 is inserted so that the display screen 5 appears flush with the front surface of the body part 4. FIG. 6 is an illustration of the front upside-down view of the front surface of the body part 4.

A predetermined number of the screws 8 are placed through designated holes on the back of the music tuner 6 and corresponding holes on the back of the body part 4. In the preferred embodiment of the invention, the number of screws 8 is two. FIG. 5 is an illustration of the back view of the music tuner 6 with a battery cap 7. FIG. 7 is an illustration of the back view of the back surface of the body part 4 with the music tuner 6 affixed by the use of screws 8.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An electric stringed music instrument comprising:
a. a head part;
b. a neck part;
c. a body part, comprising a front surface and a back surface;
d. a predetermined number of strings that produce sound and are placed over the neck part and the body part; and
e. a music tuner comprising a display screen and a sound sensing device that senses sounds from the strings, wherein the music tuner is placed in the body part below the strings.

2. The electric stringed music instrument of claim 1, wherein the music tuner is integrated onto the top surface of the body part, wherein the display screen is placed beneath the strings, wherein the display screen is flush with the top surface of the body part.

3. The electric stringed music instrument of claim 1, wherein the display screen indicates the frequency of a sound from the strings and a difference from a target frequency.

4. The electric stringed music instrument of claim 1, wherein the sound sensing device senses sounds from the strings through the air.

5. The electric stringed music instrument of claim 4, wherein the sound sensing device comprises a microphone.

6. The electric stringed music instrument of claim 1, wherein the sound sensing device senses sounds by physically contacting the strings.

7. The electric stringed music instrument of claim 6, wherein the sound sensing device comprises a piezoelectric device.

8. The electric stringed music instrument of claim 1, wherein the music tuner comprises a predetermined number of buttons that, when pressed, select a corresponding target frequency to be compared to the frequency of sound from each corresponding string of the electric stringed music instrument.

9. The electric stringed music instrument of claim 1, wherein the predetermined number of string is four.

10. The electric stringed music instrument of claim 9, wherein electric stringed music instrument comprises a ukulele.

11. The electric stringed music instrument of claim 9, wherein the strings are made of nylon.
